(19) United States
(12) Patent Application Publication
(10) Pub. No.: US 2005/0165694 A1
(43) Pub. Date: Jul. 28, 2005

(54) Image forming system including server device and printers as clients

(75) Inventor: Toru Tsuzuki, Okazaki-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/043,066

(22) Filed: Jan. 27, 2005

(30) Foreign Application Priority Data
Jan. 28, 2004 (JP) 2004-020335

(51) Int. Cl. H04K 1/00

(52) U.S. Cl. 705/59

(57) ABSTRACT

A setup is provided that enables strict management of licenses, without any incorrect use of license-requiring data if a communications failure should occur, in a configuration in which an image forming device acquires and uses license-requiring data from a server device. The configuration is such that a server device and a printer are connected, together in a mutually communicable manner, and the printer acquires license-requiring data that necessitates a license for use from the server device. If it has been confirmed that the communications state between the server device and the printer has failed, license-requiring data that is stored in a memory is deleted, thus inhibiting the printer, from using that license-requiring data for printing.

### BACKGROUND OF THE INVENTION

1. Field of the Invention

The present invention relates to an image forming system in which a server device and clients such as a printer are communicably connected.

2. Description of the Related Art

A technique has been known in the art of connecting a server device to a printer serving as a client, in a mutually communicable manner, downloading data that is stored on the server device to the printer, and using that data for printing.

Japanese Patent Publication No. 3135094 discloses a technique in which font data is stored on a server device and that font data is downloaded to a storage device of a printer when the printer uses the same. Since there is no need with this configuration to provide all of the font data used by the printer in the storage device of the printer, because it can be fetched from the server device as required, the amount of data to be stored in the printer can be efficiently suppressed, enabling the provision of an inexpensive printer.

However, in a configuration in which the client, i.e., printer, uses server information, as in Japanese Patent Publication No. 3135094, a problem arises concerning how to handle any interruption in communications between the server device and the client. There is particular concern about what would happen if communications between the server device and the client are interrupted when license-requiring data that necessitates a license for use is provided from the server device. In such a case, the client is no longer under the management of the server device and thus the license-requiring data can no longer be managed by the server device, so a situation that has not been foreseen by the processing could lead to incorrect use of the license-requiring data.

### SUMMARY OF THE INVENTION

In view of the foregoing, it is an object of the invention to provide a setup that enables strict management of licenses, without any incorrect use of license-requiring data if a communications failure should occur, in a configuration in which an image forming device acquires and uses license-requiring data from a server device.

To achieve the above and other objects, there is provided an image forming system including a server device and an image forming device communicably connected to the server device. The server device includes a data storage device and a data transmission unit. The data storage device stores license-requiring data. The license-requiring data is such data that necessitates a license when the image forming device downloads the data from the data storage device. The data transmission unit transmits the license-requiring data. The image forming device includes a reception unit, an image forming portion, a confirmation unit, and an inhibiting unit. The reception unit receives the license-requiring data transmitted from the data transmission unit. The image forming portion forms an image using the license-requiring data received at the reception unit. The confirmation unit confirms a communications state between the server device and the image forming device. The inhibiting unit inhibits use of the license-requiring data by the image forming portion for printing, if the confirmation unit has confirmed that the communication state between the server device and the image forming device has failed.

Since this configuration enables the image forming device to acquire the license-requiring data from the server device, the amount of data in the image forming device can be efficiently restrained without necessitating the storage all of the license-requiring data that is likely to be used beforehand. Since printing using the license-requiring data is inhibited if the communications state between the server device and the image forming device has failed, on the other hand, this enables strict management of the license, without allowing any incorrect use of the license-requiring data.

### BRIEF DESCRIPTION OF THE DRAWINGS

The particular features and advantages of the invention as well as other objects will become apparent from the following description taken in connection with the accompanying drawings, in which:

FIG. 1 is a block diagram showing an electrical configuration of an image forming system in accordance with an embodiment of the present invention;

FIG. 2 is illustrative of the concept of the data configuration;

FIG. 3 is a flowchart illustrating status setting processing in the printer;

FIG. 4 is a continuation of FIG. 3 illustrating the status setting processing in the printer;

FIG. 5 is illustrative of read-in statuses;

FIG. 6 is a flowchart illustrating response processing by the server device;

FIG. 7 is a flowchart illustrating the concept of print processing;

FIG. 8 is illustrative of the concept of the font data configuration stored in RAM; and

FIG. 9 is a conceptual view of the configuration of the image data.

### DETAILED DESCRIPTION OF THE PREFERRED EMBODIMENTS

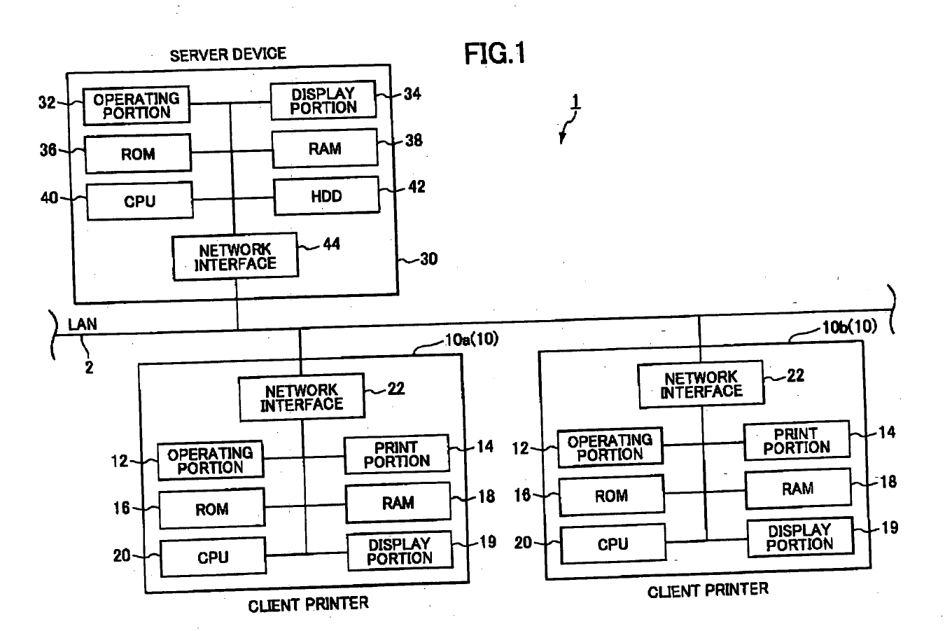

A preferred embodiment of the present invention will be described with reference to FIGS. 1 to 8 FIG. 1 is a block diagram showing the configuration of an image forming system in accordance with the embodiment.

The image forming system 1 includes a server device 30 connected to a local area network (LAN) 2, and a plurality of printers such as laser printers 10 that act as clients and is connected through the LAN 2 to the server device 30 in such a manner as to be communicable therewith. In other words, the server device 30 and each of the printers 10 can transfer data mutually.

The server device 30 is configured from a computer and includes a hard disk drive (hereinafter abbreviated to “HDD”) 42 that can read, write, and delete data. The HDD 42 has a storage area for storing license-requiring data. The license-requiring data is such data that necessitates a license at the side of client for use and is used at the client upon downloading the same. The license-requiring data that is stored in the HDD 42 can be provided through the LAN 2 to each printer 10 acting as a client.

The server device 30 further includes an operating portion 32 such as a keyboard or mouse that receives input operations from the outside, a display portion 34, a ROM 36, a RAM 38, a CPU 40, and a network interface 44. The configuration is such that the license-requiring data is transmitted to the printer 10 by the network interface 44.

The printer 10 includes an operating portion 12 such as buttons, numeric keys, or a touch panel, a print portion 14 that prints onto paper, a ROM 16, a RAM 18, a CPU 20, a display portion 19, and a network interface 22. The RAM 18 is set up to store license-requiring data that is transmitted from the server device 30 and received by the network interface 22 of the printer 10. The network interface 22 also has the function of transmitting information to the server device 30.

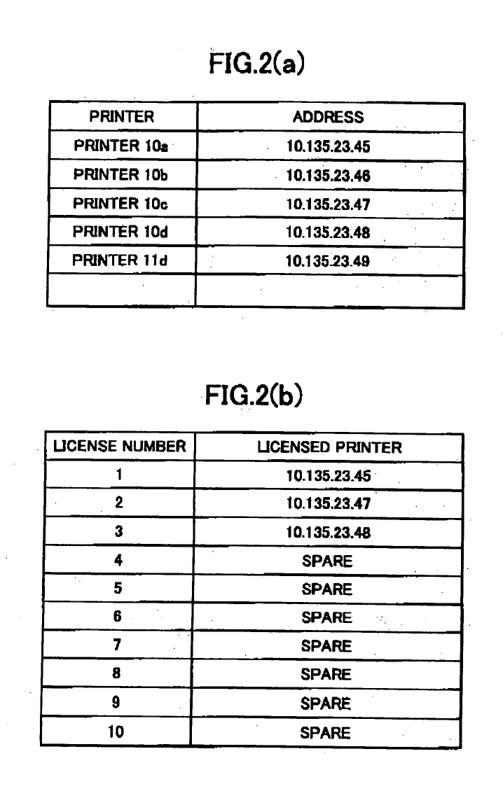

As shown illustratively in FIG. 2(a), an Internet Protocol (IP) address is set for each printer 10. The server device 30 can specify each printer by this IP address. A table for managing information relating to devices that grant licenses, out of the devices connected to the LAN 2, is stored in the RAM 38 of the server device 30, as shown in FIG. 2(b). The table shown in FIG. 2(b) will hereinafter be referred to as “license use client table”. The license use client table stores therein the IP addresses of the printers to which the server device 30 supplied the license-requiring data. Note that specific details of the flow of processing using this table will be given later.

In this embodiment, particular font data that necessitates a license is exemplified as the license-requiring data. In the following description, font data which necessitates a license will be referred to as “license-requiring font data”, font data which is fetched from the server device 30 but which does not necessitate a license as “license-unnecessary font data”, and font data which is stored beforehand in the printer 10 as “normal font data”.

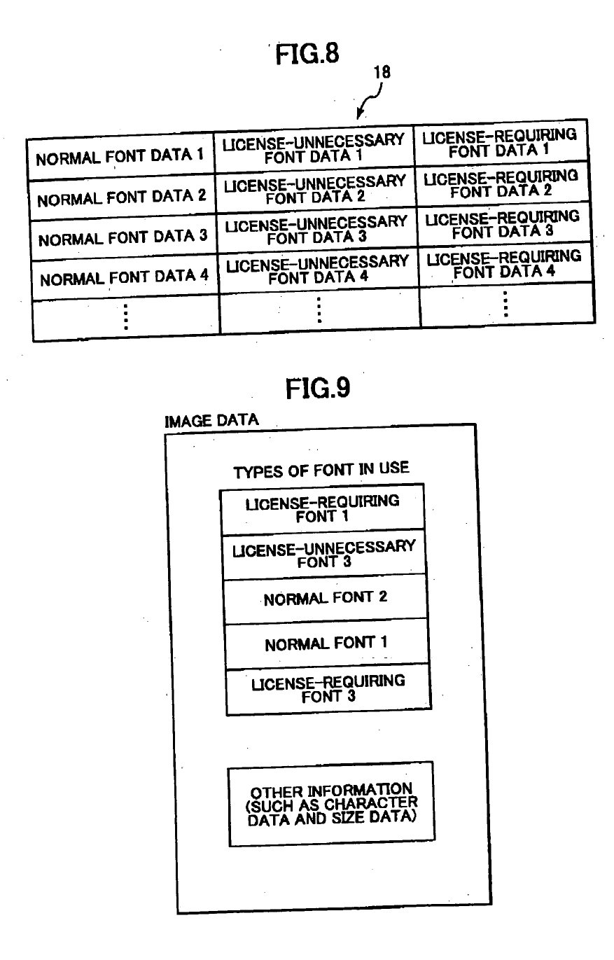

The print portion 14 of the printer 10 is configured to form an image based on image data received from an external device by using normal font data, and also to form an image by using license-requiring font data stored in the RAM 18 when the image data received from the external device includes instructions to use license-requiring font data when forming an image. Note that specific details of the print processing will be given later. The font data stored in the RAM 18 is stored in a state shown conceptually in FIG. 8, with the normal font data, license-unnecessary font data, and license-requiring font data being used either in common or selectively in accordance with the structure of the image data.

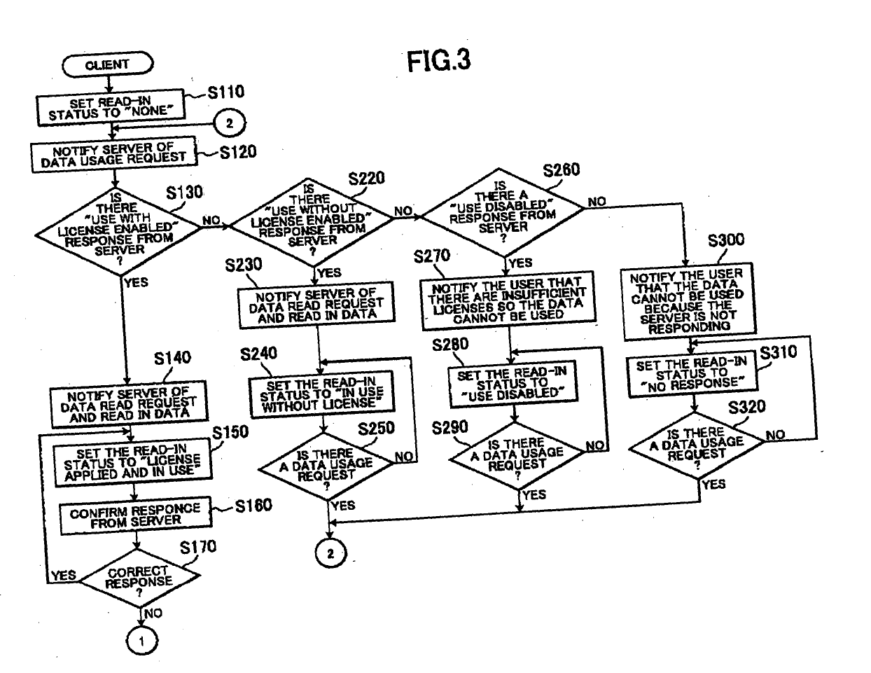

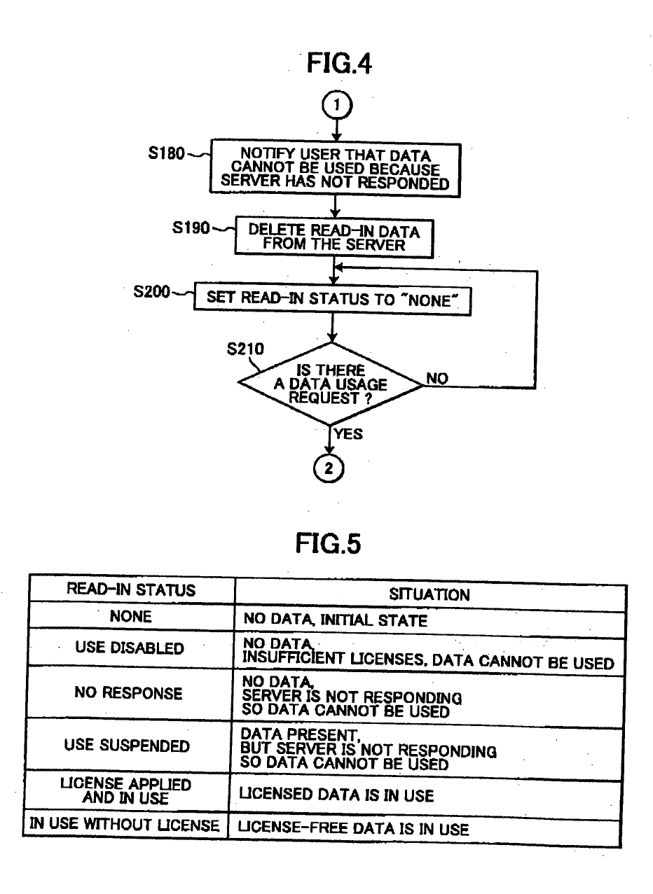

The description now turns to the flow of processing relating to downloading the license-requiring data from the server device 30. Flowcharts illustrating processing performed by the printer 10 are shown in FIGS. 3 and 4. The processing is for setting transmission/reception states of the printer 10 with respect to the server. Specifically, the printer 10 is set to one of six states shown in FIG. 5: “none”, “use disabled”, “no response”, “use suspended”, “license applied and in use”, and “in use without license”.

The printer 10 executes a program as shown in FIGS. 3 and 4, based on the fulfillment of predetermined conditions. A number of examples of these predetermined conditions could be considered, such as turning the power on, the lapse of a predetermined period of time, or an instruction by the user, but in this case the program is assumed to be started by turning the power on. When the program starts up, the read-in status is first set to “none” as the initial setting (S110). The server device 30 is then notified of a data usage request at S120. In response to the data usage request, the server device 30 may transmit some sort of response to the printer 10. Otherwise, no response is transmitted from the server device 30 to the printer 10. In the case where the server device 30 responds to the data usage request, different processing is executed in the side of the printer 10 depending upon the contents of the response from the server device 30. The following description first deals with the types of response from the server device 30.

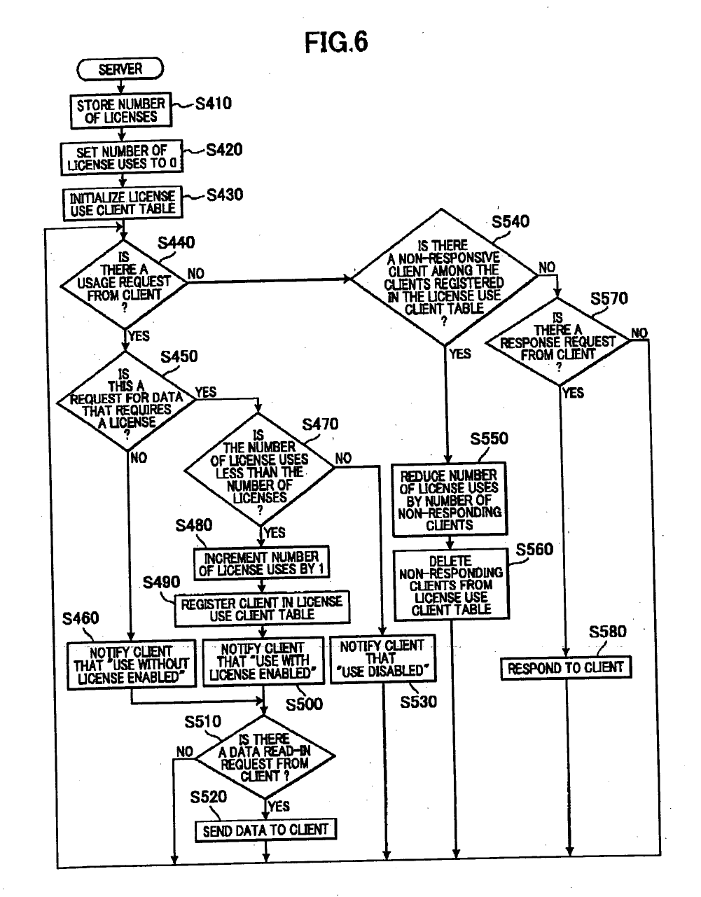

The server device 30 is designed to execute processing such as that shown in the flowchart of FIG. 6. This program first stores the number of licenses after the program has started, then sets the number of license uses to 0 as an initial setting. The number of licenses means the maximum number of printers that are permitted to be supplied with license-requiring data from the server. In this embodiment, the number of licenses is set to 10 and this number is determined by the user. Specifically, the number of licenses is set to 10 by the user inputting 10. However, the number of licenses could be set to a fixed value that cannot be changed by the user.

The license use client table is then initialized (S430). The license use client table is a listing for managing information relating to devices that grant licenses, wherein a data storage area capable of storing the same number of IP addresses as the number of licenses is reserved in the RAM 38 of the server device 30. More specifically, the IP address of each device that is currently granted a license is registered in the RAM 38. The server device 30 provides the license-requiring data only to devices having IP addresses registered in the RAM 38. The processing of S430 first initializes all of the storage areas to a state in which no IP address data is registered therein.

In S440, the CPU 40 then determines whether or not there is a usage request from one of the printers 10. This determination processing determines whether the usage request of S120 of FIG. 3 has been acquired by the server device 30 and, if it has been acquired (YES at S440) the flow proceeds to S450. If the usage request has not been acquired (NO at S440), the CPU 40 determines whether or not there is a non-responsive clients among the clients registered in the license use client table (S540). If the non-responsive client does riot exist (NO at S540), the flow proceeds to S570.

If there is a usage request from a client (YES at S440), the CPU 40 determines whether or not this is a request for data that necessitates a license, i.e., license-requiring data. The usage request is either a usage request for license-requiring data or a usage request for data which does not necessitate a license but is to be acquired from the server device, i.e., license-unnecessary data. The type of data specified by the usage request is determined in S450. If the type of data is such that it does not necessitate a license (NO at S450), the flow proceeds to S460 and the client is notified that “license-unnecessary use enabled” indicating that the use of the license-unnecessary data is permitted. If the answer is YES at S450, on the other hand, the CPU 40 determines at S470 whether or not there is a spare license. In other words, the processing at S470 determines whether or not the number of uses that are currently registered is greater than the number of licenses (in this case, 10).

If it is determined that the number of licenses is greater than the number of uses as shown in FIG. 2(b) (YES at S470), the CPU 40 increments the number of license uses by 1 at S480 and registers the client in the license use client table at S490. More specifically, the CPU 40 writes the IP address of the printer 10 that made the usage request into a spare area of the license use client table, and notifies the client that “use with license enabled” (S500) indicating that the use of license-requiring data is permitted. The CPU 40 then determines whether or not there is a data read request from the printer 10 (S510) and, if there is one, it transmits the data to the client at S520.

If the answer is NO at S470, that is, if the number of license uses and the number of license in use are the same, the CPU 40 determines that there are insufficient licenses and notifies the printer 10 that “use disabled” indicating that the use of license-requiring data is not permitted.

If the notification of S460, S500, or S530 occurs, the CPU 40 executes the determination processing of S130, S220, and S260 of FIG. 3. The processing of S130, S220, and S260 determines whether the response from the server device 30 is a “use with license enabled” notification, a “use without license enabled” notification, or a “use disabled” notification. The communications state between the server device 30 and the printer 10 is confirmed by this determination processing.

First of all, if the response is determined to be “use with license enabled” at S130, the flow proceeds to S140 where the server device 30 is notified of the data read request and data is read from the server device 30. The read request for the license-requiring data is issued at S140, the processing of S520 corresponding to the read request is executed, and the license-requiring data is transmitted from the server device 30 to the printer 10. The read-in status is then set to “license applied and in use”. After this setting, the response from the server device 30 is confirmed at S160, and the CPU 49 confirms whether or not the operation of the server device 30 has been posted to the printer 10.

On the server side, response requests from the printers 10 are detected substantially regularly, as shown at S570 and S580 in FIG. 6, and processing is done to transmit each response request to the server device 30 at S160 of FIG. 3 and also wait for response requests from the server. If a response request is received by the server device 30 as shown at S570 and S580 in FIG. 6 (YES at S570), a response signal indicating normal operation is transmitted to the printer 10 (S580). If the printer 10 does not obtain a normal response from the server device 30 that has transmitted the response request (if a normal response has not been obtained after a fixed period from the response request, for example), the communications state has failed and the flow proceeds to S180 of FIG. 4. Note that if it is determined that there is no usage request at S440 and also that there is a non-responding client at S540 (by determination processing that will be described later), the flow moves to the above-described branch S570.

The loop from S170 to S150 repeats for as long as there is a normal response (in other words, for as long as a normal response from the server device 30 can be detected), and the read-in status is held at “license applied and in use”. Note that the determination processing of S170 serves as confirmation means for confirming the communications state between the server device 30 and the image forming device. This confirmation means confirms the communications state between the server device 30 and the printer 10 if a predetermined confirmation condition is satisfied. Examples of such confirmation conditions include “whether or not a predetermined number of pages have been printed” and “whether or not a predetermined time has elapsed”. Of these, a predetermined standby time could be set between S150 and S160, as the confirmation condition for “whether or not a predetermined time has elapsed”, and in that case a loop is formed by S150, S160, and S170 at a substantially constant spacing corresponding to the lapse of the standby time. In this manner, the confirmation means is configured in such a manner that it confirms whether or not a desired communications result (normally the acquisition of information concerning normal operation) has been obtained from the server device 30 with respect to predetermined information, when it tests the transmission of that predetermined information (information that requests a response) to the server device 30. In addition, the configuration is such that if it is confirmed that the desired communications result has not been acquired by the confirmation means (in other words, information concerning normal operation has not been acquired), printing by the print portion 14 using the license-requiring data is inhibited by inhibiting means.

More specifically, if it is determined at S170 that there is no normal response (in other words, that a normal response from the server device 30 could not be detected at the printer 10), the flow proceeds to S180 of FIG. 4, and the user is notified at S180 of the fact that license-requiring data cannot be used because the server device 30 has not responded. This notification can be done by displaying descriptive information concerning that fact on a display portion 19. Subsequently, the data that was read in from the server device 30 (the license-requiring data and license-unnecessary data) is deleted from the RAM 18. Printing using the license-requiring data is inhibited by the execution of this processing.

As can be understood from the flow of this processing, this embodiment of the present invention ensures that the license-requiring data that is stored in the RAM 18 is deleted if it is confirmed that the communications state between the server device 30 and the printer 10 has failed (in this case, if a normal response from the server device 30 to the printer 10 cannot be detected), and thus printing by the printer 10 using the license-requiring data is inhibited. The read-in status after the deletion processing of S190 is set to “none” (S200). This status is held at least until there is a usage request at the server device 30 (in other words, until the answer at S210 is YES).

Returning to FIG. 3, if the response from the server device 30 is “use without license enabled” (see S460 in FIG. 6), it is determined that there is no “use with license enabled” response at S130, and the answer at S220 is determined to be YES. A data read request is sent to the server device 30 at S230, and license-unnecessary data is downloaded from the server device 30. The read-in status is set to “in use without license” at S240. This status is held at least until there is a usage request at the server device 30 (in other words, until the answer at S250 is YES).

If the response from the server device 30 is “use disabled” (see S530 in FIG. 6), on the other hand, it is determined that there is no “use with license enabled” response at S130, the answer at S220 is determined to be NO, and that at S260 is YES. The user is notified at S270 that there are insufficient licenses so the data cannot be used. This notification can be done by displaying descriptive information concerning that fact on the display portion 19. The read-in status is set to “use disabled” at S250. This status is held at least until there is a usage request at the server device 30 (in other words, until the answer at S290 is YES). If the answer at S130 and S220 is NO and also the answer at S260 is NO, the server device 30 is in a non-responding state and thus the user is notified that data from the server device 30 cannot be used because the server device 30 is not responding (S300). This notification can be done by displaying descriptive information concerning that fact on the display portion 19. The read-in status is then set to “no response”. This status is held at least until there is a usage request at the server device 30 (in other words, until the answer at S320 is YES).

Note that the configuration is such that the read-in status at S200, S240, S260, and S310 is held at least until there is a new data request at the server device 30. In other words, the setting remains without change until there is a new usage request with respect to the server device 30. Various different conditions could be considered as conditions that generate data usage requests for the server device 30, such as a condition relating to whether or not a predetermined duration of time has elapsed since the status was set, or a condition relating to whether or not a setting input for a usage request with respect to the server device 30 has been done by the user. As an example of the processing in this case, the configuration could be such that a usage request is made with respect to the server device 30 after a predetermined time has elapsed after each status setting processing S200, S240, S260, and S310, and the loop is repeated and each status setting is held until the time has elapsed. Note that usage requests to the server device 30 are invited again based on the condition completion in this case, but the flow could equally well be such that the branch processing of S200, S240, S260, and is S310 is omitted.

Note that the server device 30 performs processing to manage the number of licenses in use, as shown at S540 to S560 in FIG. 6. In this case, every time it has been determined that there is no usage request at S440, the CPU 40 determines whether or not there is a non-responding printer among the printers 10 registered in the license use client table (S540), the flow proceeds to S550 if there is one, and the number of license uses is decremented by the number of non-responding clients and also the IP address of each non-responding client is deleted from the license use client table. If non-responding printers are monitored each time a predetermined condition is completed in this manner, and non-responding devices are deleted from the register, printers that are assumed to be unnecessary can be deleted efficiently and the licensees can be managed as appropriate.

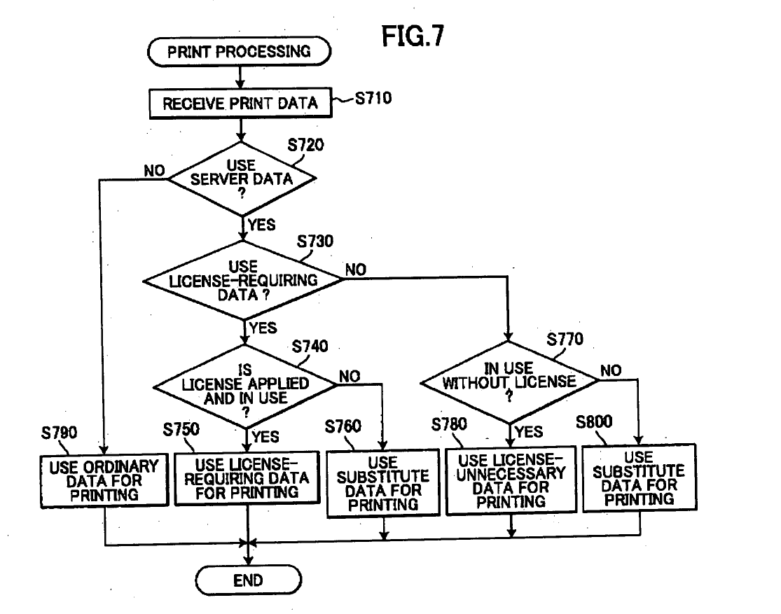

The description now turns to print processing, with reference to FIG. 7.

FIG. 7 is a conceptual flowchart of an example of the print processing. The printer 10 is connected to a computer (not shown in the figures) by the LAN 2 or another line, with the configuration being such that the printer 10 receives and prints image data from that computer. During the print processing, the printer 10 first receives print data (image data) (S710) and confirms the details of that print data (image data). The image data is configured so that it is possible to specify which font is to be used, as shown conceptually in FIG. 9. The image data of FIG. 9 also includes information relating to each font type that is used and other information such as character data and character size data. This information relating to font type is equivalent to instruction information for instructing the formation of an image by using license-requiring data. In other words, if a license-requiring data is included therein, this means that there is an instruction for using the license-requiring font data for printing. Note that the information relating to font type could have any data configuration provided there is information that can specify which type of font is used.

As shown in FIG. 7, if the use of server data (in this case license-requiring font data and license-unnecessary font data) is not instructed, the flow proceeds to S790 and printing is done by using only normal font data for the fonts. If the use of at least one of license-requiring font data and license-unnecessary font data is instructed, on the other hand, the flow proceeds to S730 and the system confirms that the current status is “license applied and in use”.

If the status is “license applied and in use”, the flow proceeds to S750 and, since the license-requiring font data such as that of FIG. 8 is stored in the RAM 18, printing is done using that data, as well as normal data and license-unnecessary font data if necessary. If the status is not “license applied and in use”, on the other hand, the flow proceeds to S760 and printing is done using substitute data such as substitute data for the license-requiring font data that is selected from among the normal font data. If it is determined at S730 that license-requiring font data is not used, the system confirms whether or not the status is “in use without license” at S770. If the status is “in use without license”, the license-unnecessary data is in the RAM 18 and thus is used for printing, as well as normal font data if necessary (S780). If the status is “in use without license”, on the other hand, the printing is done by using normal font data as a substitute for the license-unnecessary font data.

This embodiment is configured for a specific type of data (font data, in this case) in such a manner that an image can be formed by using license-requiring data and normal data for which a license is not necessary, either in common or selectively. If the confirmation means has determined that the communications state between the server device 30 and the printer 10 has failed, the inhibiting means deletes license-requiring data that is stored in the RAM 18 and the image forming means (in other words, the print portion 14) does not use license-requiring data but forms the image, by using normal data.

Since the above-described configuration ensures that the image forming device can acquire the license-requiring data from the server device, the quantity of data in the image forming device can be suppressed efficiently, without necessitating the provision of all of the license-requiring data that can be used in the image forming device beforehand. This configuration also enables strict management of the license, without allowing any incorrect use of the license-requiring data, to ensure that printing using the license-requiring data is inhibited if the communications state between the server device and the image forming device has failed. Another method that could be considered is to provide the license-requiring data is provided with an expiry period and perform the download again each time that period expires, but the method of the present invention provides effective management without increasing the number of downloads.

Although the present invention has been described with respect to a specific embodiment, it will be appreciated by one skilled in the art that a variety of changes may be made without departing from the scope of the invention. For example, with the above-described embodiment, font data was used as an example of the specific type of data, but the data could equally well be other kinds of data such as firmware data or macro data.

With the above-described embodiment, a computer was used as an example of the server device, but an image forming device having the server functions could equally well be used instead. The server functions refer to, for example, a function for storing the license-requiring data, a function for providing mutual data communications with the printer 10, and a function for managing a plurality of the printers 10, such as a printer provided with server functions.

1. An image forming system comprising:
a server device; and
an image forming device communicably connected to the server device,
wherein the server device comprises:
a data storage device that stores license-requiring data, the license-requiring data being such data that necessitates a license when the image forming device downloads the data from the data storage device; and
a data transmission unit that transmits the license-requiring data,
wherein the image forming device comprises:
a reception unit that receives the license-requiring data transmitted from the data transmission unit;
an image forming portion that forms an image using the license-requiring data received at the reception unit;
a confirmation unit that confirms a communications state between the server device and the image forming-device; and
an inhibiting unit that inhibits use of the license-requiring data by the image forming portion for printing, if the confirmation unit has confirmed that the communication state between the server device and the image forming device has failed.

2. The image forming system according to claim 1, wherein the image forming device further comprises a data storage device that stores the license-requiring data received at the reception unit, wherein the inhibiting unit deletes the license-requiring data stored in the data storage device of the image forming device, if the confirmation unit has confirmed that the communication state between the server device and the image forming device has failed.

3. The image forming system according to claim 2, wherein when the image forming portion forms an image based on a first type of image data, the first type of image data containing an instruction to use the license-requiring data, the image forming portion forms the image by using the license-requiring data stored in the data storage unit of the image forming device.

4. The image forming system according to claim 3, wherein when the image forming portion forms an image based on a second type of image data different from the first type of image data, the image forming portion forms the image by using both the license-requiring data and normal data, the normal data being such that a license of the server device is not necessitated, or by selectively using one of the license-requiring data and the normal data.

5. The image forming system according to claim 4, wherein when the image forming portion forms the image based on the second type of image data, the inhibiting unit deletes the license-requiring data stored in the data storage device of the image forming device, if the confirmation unit has confirmed that the communication state between the server device and the image forming device has failed, and the image forming portion forms the image not using the license-requiring data but using the normal data.

6. The image forming system according to claim 5, wherein the second type of image data is one selected from a group consisting of font data, firmware data, and macro data.

7. The image forming system according to claim 1, wherein the confirmation unit confirms the communications state between the server device and the image forming device when a predetermined condition is met.

8. The image forming system according to claim 1, wherein the image forming device further comprises a, transmission unit that transmits predetermined information to the server device, wherein the confirmation unit checks whether or not a predetermined communications result is received from the server in response to the predetermined information when transmission of the predetermined information is tested by the transmission unit, and wherein the inhibiting unit inhibits the image forming portion to print using the license-requiring data, if the confirmation unit confirms that the predetermined communications result has not been obtained.

9. The image forming system according to claim 1, wherein the server device further comprises a setting unit that sets the use of the license-requiring data stored in the data storage device to disabled, wherein the confirmation unit checks whether or not the use of the
license-requiring data is set to disabled by the setting unit, and the inhibiting unit inhibits the use of the license-requiring data for printing if the confirmation unit confirms that the use of the license-requiring data is set to disabled.

10. The image forming system according to claim 1, wherein the image forming device further comprises a notification unit that notifies that the use of the license-requiring data for printing is inhibited by the inhibiting unit.

11. An image forming device communicably connected, in use, to a server device, the image forming device comprising:
a reception unit that receives license-requiring data from the server device, the license-requiring data being such data that necessitates a license of the server when downloading;
an image forming portion that forms an image using the license-requiring data received at the reception unit;
an interface connected, in use, to the server device;
a confirmation unit that confirms a communications state between the server device and the interface; and
an inhibiting unit that inhibits use of the license-requiring data by the image forming portion for printing, if the confirmation unit has confirmed that the communication state between the server device and the interface has failed.

12. The image forming device according to claim 11, further comprising a data storage device that stores the license-requiring data received at the reception unit, wherein the inhibiting unit deletes the license-requiring data stored in the data storage device, if the confirmation unit has confirmed that the communication state between the server device and the interface has failed.

13. The image forming device according to claim 12, wherein when the image forming portion forms an image based on a first type of image data, the first type of image data containing an instruction to use the license-requiring data, the image forming portion forms the image by using the license-requiring data stored in the data storage unit.

14. The image forming device according to claim 13, wherein when the image forming portion forms an image based on a second type of image data different from the first type of image data, the image forming portion forms the image by using both the license-requiring data and normal data, the normal data being such that a license of the server device is not necessitated, or by selectively using one of the license-requiring data and the normal data.

15. The image forming device according to claim 14, wherein when the image forming portion forms the image based on the second type of image data, the inhibiting unit deletes the license-requiring data stored in the data storage device, if the confirmation unit has confirmed that the communication state between the server device and the interface has failed, and the image forming portion forms the image not using the license-requiring data but using the normal data.

16. The image forming device according to claim 15, wherein the second type of image data is one selected from a group consisting of font data, firmware data, and macro data.

17. The image forming device according to claim 11, wherein the confirmation unit confirms the communications state between the server device and the interface when a predetermined condition is met.

18. The image forming device according to claim 11, further comprising a transmission unit that transmits predetermined information to the server device, wherein the confirmation unit checks whether or not a predetermined communications result is received from the server in response to the predetermined information when transmission of the predetermined information is tested by the transmission unit, and wherein the inhibiting unit inhibits the image forming portion to print using the license-requiring data, if the confirmation unit confirms that the predetermined communications result has not been obtained.

19. The image forming device according to claim 11, wherein the confirmation unit checks whether or not the use of the license-requiring data is set to disabled by the server device, and the inhibiting unit inhibits the use of the license-requiring data for printing if the confirmation unit confirms that the use of the license-requiring data is set to disabled.

20. The image forming device according to claim 11, further comprising a notification unit that notifies that the use of the license-requiring data for printing is inhibited by the inhibiting unit.
